(19) United States
(12) Patent Application Publication
(10) Pub. No.: US 2011/0096758 A1
(43) Pub. Date: Apr. 28, 2011

(54) METHOD FOR ENHANCING THROUGHPUT OF A WLAN MODULE COLLOCATED WITH A BT SLAVE MODULE, AND ASSOCIATED WIRELESS COMMUNICATION APPARATUS AND WIRELESS COMMUNICATION MODULE

(76) Inventors: Li-Chun Ko, Taipei City (TW); Chih-Hao Yeh, Taipei County (TW); Hong-Kai Hsu, Taipei County (TW); Shun-Yong Huang, Taipei City (TW)

(21) Appl. No.: 12/605,376

(22) Filed: Oct. 26, 2009

(51) Int. Cl. H04W 80/00; H04B 7/00

(52) U.S. Cl. 370/338; 455/41.2

(57) ABSTRACT

A method for enhancing throughput of a Wireless Local Area Network (WLAN) module collocated with a Bluetooth (BT) slave module includes: detecting whether timing critical data of the BT slave module exists; and allowing the WLAN module to perform wireless communication when it is detected that no timing critical data of the BT slave module exists. An associated wireless communication apparatus includes: a BT slave module; a WLAN module collocated with the BT slave module; and a controller arranged to control operations of the BT slave module and the WLAN module, wherein the controller detects whether timing critical data of the BT slave module exists, and allows the WLAN module to perform wireless communication when it is detected that no timing critical data of the BT slave module exists. An associated wireless communication module such as the BT slave module is further provided.

### BACKGROUND

The present invention relates to wireless communication control, and more particularly, to a method for enhancing throughput of a Wireless Local Area Network (WLAN) module collocated with a Bluetooth (BT) slave module, and an associated wireless communication apparatus and an associated wireless communication module.

According to the related art, the term “Wi-Fi” is typically utilized for referring to WLAN modules that comply with IEEE 802.11 standards since the Wi-Fi Alliance provides a service regarding certification of products based on the IEEE 802.11 standards. For example, the Wi-Fi certification may warrant interoperability between different wireless modules, and more particularly, WLAN modules. Although many products on the market may have passed the Wi-Fi certification, and can therefore be referred to as Wi-Fi certified modules, this does not imply that a WLAN module without a certain Wi-Fi logo is incompatible to these certified products.

According to the standards known in the art, some of the BT channels (e.g. 79 frequency hopping channels) overlap at least a portion of the WLAN channels (e.g. 14 stationary channels). In a situation where a WLAN module is collocated with a BT module, and more particularly, both of them are positioned within the same portable electronic device, WLAN frames may be corrupted by wireless operations of the BT module when the BT module hops into a BT channel that overlaps a WLAN channel utilized by the WLAN module. Similarly, BT frames may be affected by wireless operations of the WLAN module when the BT module hops into a BT channel that overlaps a working channel of the WLAN module. According to the related art, it is suggested to utilize Adaptive Frequency Hopping (AFH) techniques as a solution to these problems. However, the AFH techniques may be of no use in some circumstances.

More specifically, in a situation where the BT and WLAN modules are collocated on the same circuit board within a small housing, the isolation is limited, where the transmission power of one of the BT and WLAN modules typically saturates the receiver of the other via the circuit board. As a result, the BT and WLAN modules cannot perform transmitting (TX) and receiving (RX) operations individually at the same time. Thus, a novel method is therefore required for properly maintaining timing critical data delivery of a BT slave module while minimizing its impact on the throughput of a collocated WLAN module.

### SUMMARY

It is therefore an objective of the claimed invention to provide a method for enhancing throughput of a Wireless Local Area Network (WLAN) module collocated with a Bluetooth (BT) slave module, and to provide an associated wireless communication apparatus and an associated wireless communication module, in order to solve the above-mentioned problems.

An exemplary embodiment of a method for enhancing throughput of a WLAN module collocated with a BT slave module comprises: detecting whether timing critical data of the BT slave module exists; and allowing the WLAN module to perform wireless communication when it is detected that no timing critical data of the BT slave module exists.

An exemplary embodiment of an associated wireless communication apparatus comprises: a BT slave module; a WLAN module collocated with the BT slave module; and a controller arranged to control operations of the BT slave module and the WLAN module, wherein the controller detects whether timing critical data of the BT slave module exists, and allows the WLAN module to perform wireless communication when it is detected that no timing critical data of the BT slave module exists.

An exemplary embodiment of an associated wireless communication module is arranged to operate according to a first mechanism when timing critical data of the wireless communication module exists, and operate according to a second mechanism when no timing critical data of the wireless communication module exists.

An exemplary embodiment of a wireless communication apparatus comprises a first wireless communication module and a second wireless communication module, wherein spectrums of signals respectively transceived by the first and second wireless modules are overlapped, and the wireless communication apparatus is arranged to parse data buffered in the first wireless communication module, determine whether timing critical data of the first wireless communication module exists, and control operation of the first wireless communication module or the second wireless communication module according to a determining result regarding the timing critical data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication apparatus according to a first embodiment of the present invention.

FIG. 2 is a flowchart of a method for enhancing throughput of a Wireless Local Area Network (WLAN) module collocated with a Bluetooth (BT) slave module according to one embodiment of the present invention.

FIG. 3 illustrates a working flow comprising implementation details of the method shown in FIG. 2 according to an embodiment of the present invention.

FIG. 4 illustrates the BT path status and the WLAN path status arranged based upon the BT buffer status according to the embodiment shown in FIG. 3.

FIG. 5 illustrates a working flow comprising implementation details of the method shown in FIG. 2 according to another embodiment of the present invention.

FIG. 6 illustrates the BT path status and the WLAN path status arranged based upon the BT buffer status according to the embodiment shown in FIG. 5.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one module is coupled to another module, that connection may be through a direct electrical connection, or through an indirect electrical connection via other modules and connections.

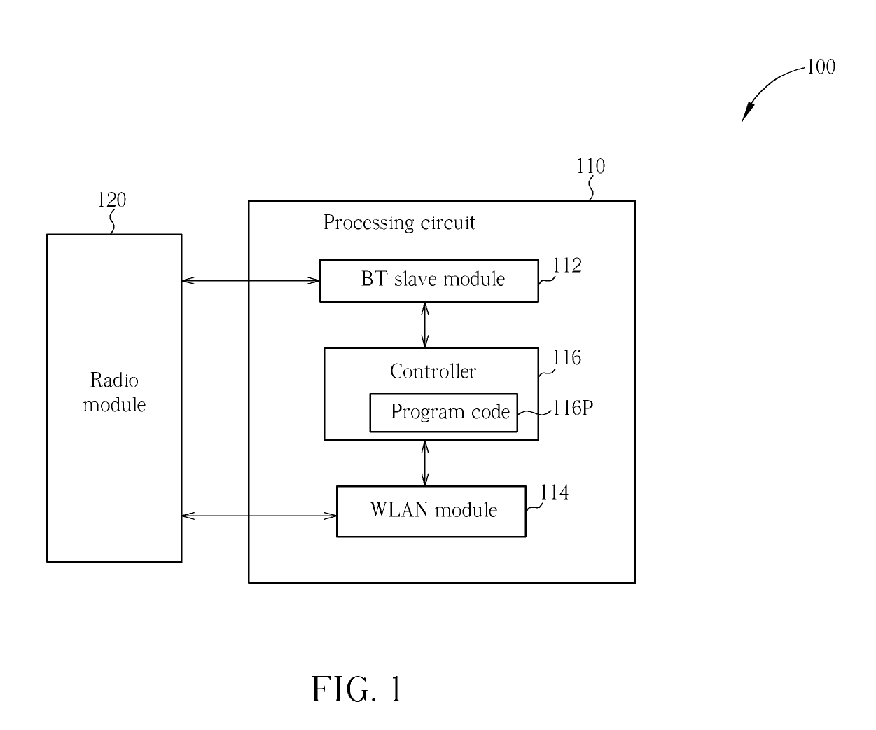

Please refer to FIG. 1, which illustrates a diagram of a wireless communication apparatus 100 according to a first embodiment of the present invention, where the wireless communication apparatus 100 of this embodiment is a portable electronic device. For example, the portable electronic device may represent a laptop computer. This is for illustrative purposes only, and is not meant to be a limitation of the present invention. According to a variation of this embodiment, the portable electronic device may represent a personal digital assistant (PDA). According to another variation of this embodiment, the portable electronic device may represent a handy device having multiple functions such as PDA functions and telecommunication functions. According to another variation of this embodiment, the wireless communication apparatus 100 may represent a desktop computer.

As shown in FIG. 1, the wireless communication apparatus 100 comprises a processing circuit 110 and a radio module 120, where the processing circuit 110 comprises a Bluetooth (BT) slave module 112 (labeled “BT slave module” in FIG. 1), a Wireless Local Area Network (WLAN) module 114 (labeled “WLAN module” in FIG. 1) collocated with the BT slave module 112, and a controller 116. For example, the processing circuit 110 may represent a circuit board having a plurality of components mounted thereon. This is for illustrative purposes only, and is not meant to be a limitation of the present invention. According to a variation of this embodiment, the processing circuit 110 may represent an integrated circuit (IC) or a microchip. According to another variation of this embodiment, the processing circuit 110 may represent a circuit board having at least one IC/microchip and associated components mounted thereon.

In this embodiment, the BT slave module 112 and the WLAN module 114 share the same radio module 120. In practice, the radio module 120 may comprise at least one antenna for radio transmitting and radio receiving, and may further comprise at least one filter and/or at least one amplifier. In addition, the wireless communication apparatus 100 of this embodiment can perform wireless communication. More particularly, under control of the controller 116 executing program code 116P, each of the BT slave module 112 and the WLAN module 114 can perform transmitting (TX) and receiving (RX) operations by utilizing the radio module 120. For example, in a situation where the program code 116P represents Read Only Memory (ROM) code, the controller 116 may represent a hardware controller with the ROM code embedded therein. This is for illustrative purposes only, and is not meant to be a limitation of the present invention. According to a variation of this embodiment, the program code 116P may represent firmware code, while the controller 116 may represent a micro control unit (MCU) executing the firmware code. According to another variation of this embodiment, the program code 116P may represent software code, while the controller 116 may represent a micro processing unit (MPU) executing the software code.

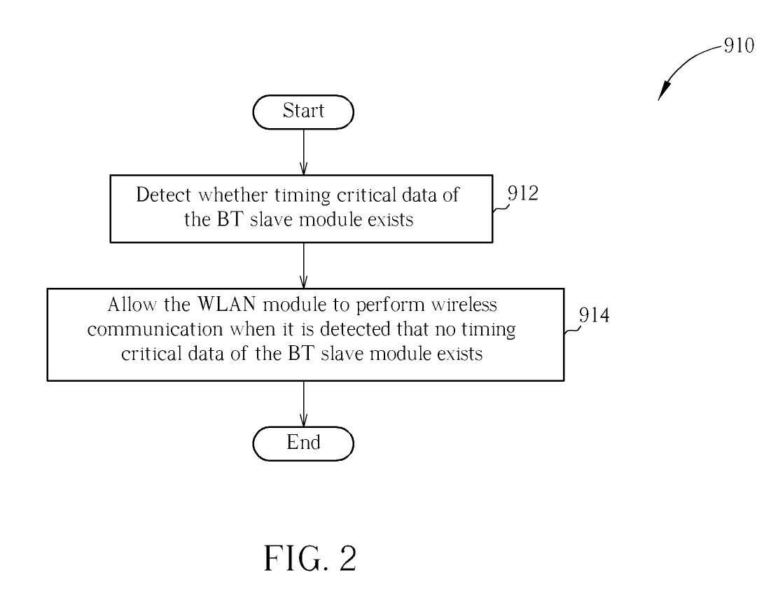

According to this embodiment, the controller 116 is arranged to control operations of the BT slave module 112 and the WLAN module 114 and enhance throughput of the WLAN module 114. Implementation details are further explained according to FIG. 2.

FIG. 2 is a flowchart of a method 910 for enhancing throughput of a WLAN module collocated with a BT slave module according to one embodiment of the present invention. The method 910 shown in FIG. 2 can be applied to the wireless communication apparatus 100 shown in FIG. 1, and more particularly, the controller 116 executing the program code 116P. The method is described as follows.

In Step 912, the controller 116 detects whether timing critical data of the BT slave module 112 exists. Here, the timing critical data may represent data that is timing sensitive, such as audio streaming data, which is preferred to be played back by a speaker or an earphone smoothly without interruption. Advanced Audio Distribution Profile (A2DP) packet is one example of the aforementioned timing critical data. In practice, the controller 116 may detect whether there is data buffered in a buffer (not shown) within the BT slave module 112. For example, the controller 116 determines that no timing critical data of the BT slave module exists when it is detected that there is no data buffered in the buffer mentioned above. In another example, when it is detected that there is data buffered in the buffer, the controller 116 parses the data buffered in the buffer in order to detect whether the timing critical data of the BT slave module 112 exists. When the data buffered in the buffer is timing critical, in yet another example, the controller 116 further determines whether the buffered data comprises a data packet. The controller 116 may determine that no timing critical data of the BT slave module 112 exists if the buffered data does not comprise a complete data packet, but is data fragment only.

In practice, the parsing operation of Step 912 may comprise determining the packet type of a BT packet in the data buffered (or to be buffered) in the buffer, and may further comprise determining whether any timing constraint of the BT packet exists.

In Step 914, the controller 116 allows the WLAN module 114 to perform wireless communication when it is detected that no timing critical data of the BT slave module 112 exists. More particularly, when it is detected that the timing critical data exists, the controller 116 allows the BT slave module 112 to deliver the timing critical data, and prevents the WLAN module 114 from performing wireless communication.

Under the control of the controller 116 executing the program code 116P, the wireless communication apparatus 100 is capable of properly controlling the operations of the BT slave module 112 and the WLAN module 114. For example, the controller 116 may allow the BT slave module 112 to perform wireless communication except for when the WLAN module 114 is performing wireless communication. In another example, the controller 116 may prevent the BT slave module 112 from performing wireless communication or BT slave receiving (RX) operations when it is detected that no timing critical data of the BT slave module 112 exists. Or, the controller 116 may allow the BT slave module 112 to perform wireless communication when BT's communication has been blocked for a predetermined time period. As a result of the control of the controller 116 executing the program code 116P, the throughput of the WLAN module 114 can be enhanced without hindering the BT slave module 112 from delivering the timing critical data.

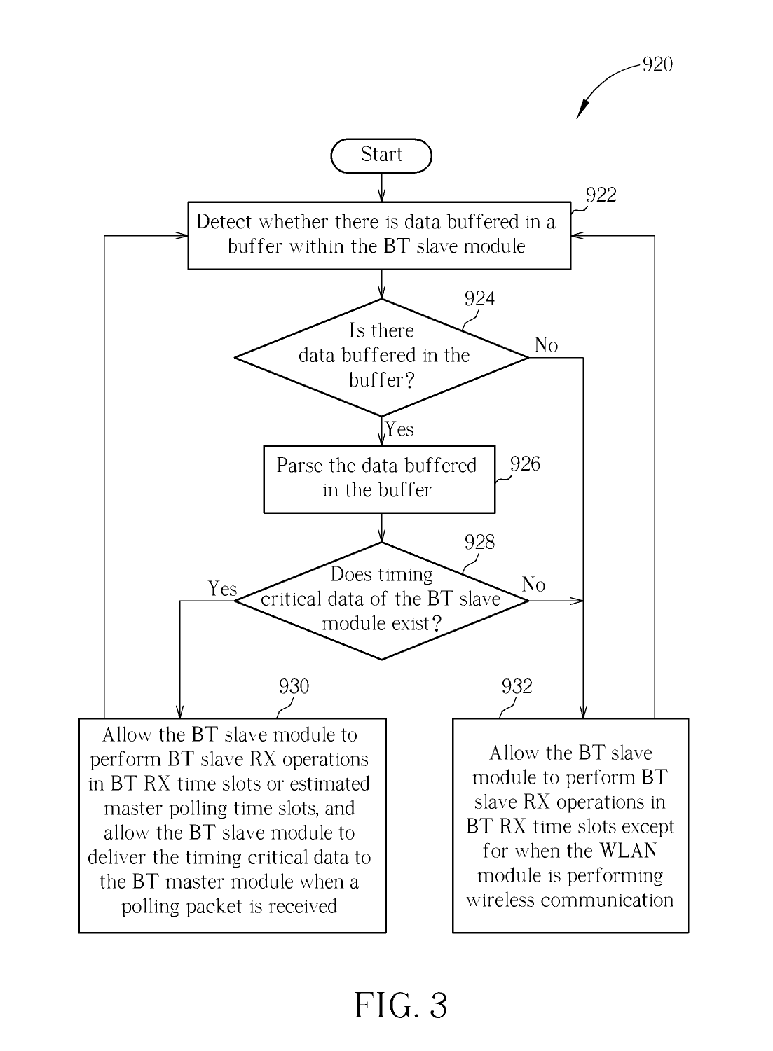

FIG. 3 illustrates a working flow 920 comprising implementation details of the method 910 shown in FIG. 2 according to an embodiment of the present invention. The controller 116 of this embodiment allows the BT slave module 112 to perform wireless communication except for when the WLAN module 114 is performing wireless communication. More particularly, the controller 116 allows the BT slave module 112 to perform BT slave RX operations except for when the WLAN module 114 is performing wireless communication.

In Step 922, the controller 116 detects whether there is data buffered in the aforementioned buffer within the BT slave module 112.

In Step 924, the controller 116 determines whether there is data buffered in the aforementioned buffer within the BT slave module 112, based upon at least one detection result of the detection of Step 922. When it is detected that there is data buffered in the buffer, Step 926 is entered; otherwise, Step 932 is entered.

In Step 926, the controller 116 parses the data buffered in the buffer. In addition, the controller may further detect whether the data buffered in the buffer comprises a complete packet for delivery or not.

In Step 928, the controller 116 determines whether the timing critical data of the BT slave module 112 exists, based upon at least one parsing result of the parsing operation of Step 926. When it is detected that the timing critical data of the BT slave module 112 exists, Step 930 is entered; otherwise, Step 932 is entered.

In Step 930, the controller 116 allows the BT slave module 112 to perform BT slave RX operations in BT RX time slots or estimated master polling time slots (i.e. the estimated polling time slots of the BT master module associated with the BT slave module 112), and allows the BT slave module 112 to deliver the timing critical data to the BT master module when a polling packet is received. After Step 930 is executed, Step 922 is re-entered.

In Step 932, the controller 116 allows the BT slave module 112 to perform BT slave RX operations in BT RX time slots except for when the WLAN module 114 is performing wireless communication. After Step 932 is executed, Step 922 is re-entered.

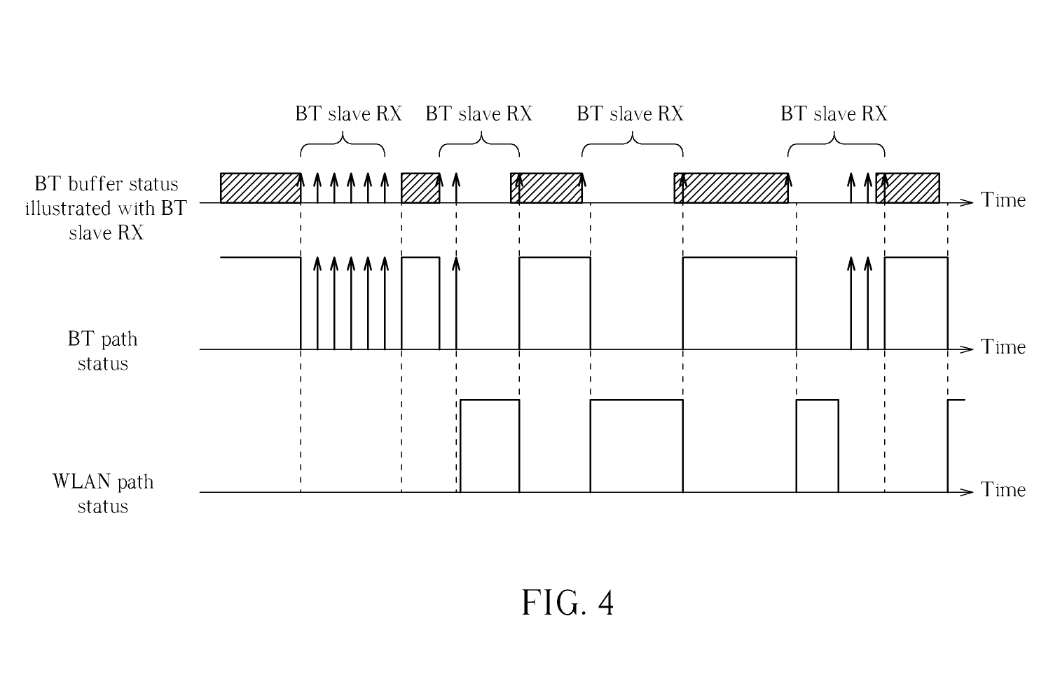

FIG. 4 illustrates the BT path status and the WLAN path status arranged based upon the BT buffer status according to the embodiment shown in FIG. 3. Here, the BT path status mentioned above represents the status of the BT path passing through the BT slave module 112 and the radio module 120, while the WLAN path status mentioned above represents the status of the WLAN path passing through the WLAN module 114 and the radio module 120. Regarding the BT buffer status shown in FIG. 4, the shaded portions represent there is timing critical data buffered in the aforementioned buffer within the BT slave module 112, where the arrows labeled “BT slave RX” represent BT slave RX operations such as those mentioned above.

Regarding the BT path status shown in FIG. 4, the high level thereof means the BT path is in an active state (e.g. a transceiving state), and the low level thereof means the BT path is in an inactive state (e.g. a non-transceiving state). Similarly, regarding the WLAN path status shown in FIG. 4, the high level thereof means the WLAN path is in an active state, and the low level thereof means the WLAN path is in an inactive state. Please note that the controller 116 allows the BT slave module 112 to perform BT slave RX operations in BT RX time slots except for when the WLAN module 114 is performing wireless communication. Thus, when the WLAN path is in its active state, the controller 116 prevents the BT slave module 112 from performing any BT slave RX operation, and therefore, prevents the wireless communication of the WLAN module 114 from being hindered by any BT slave RX operation. As a result, the throughput of the WLAN module 114 can be greatly enhanced in contrast to the related art.

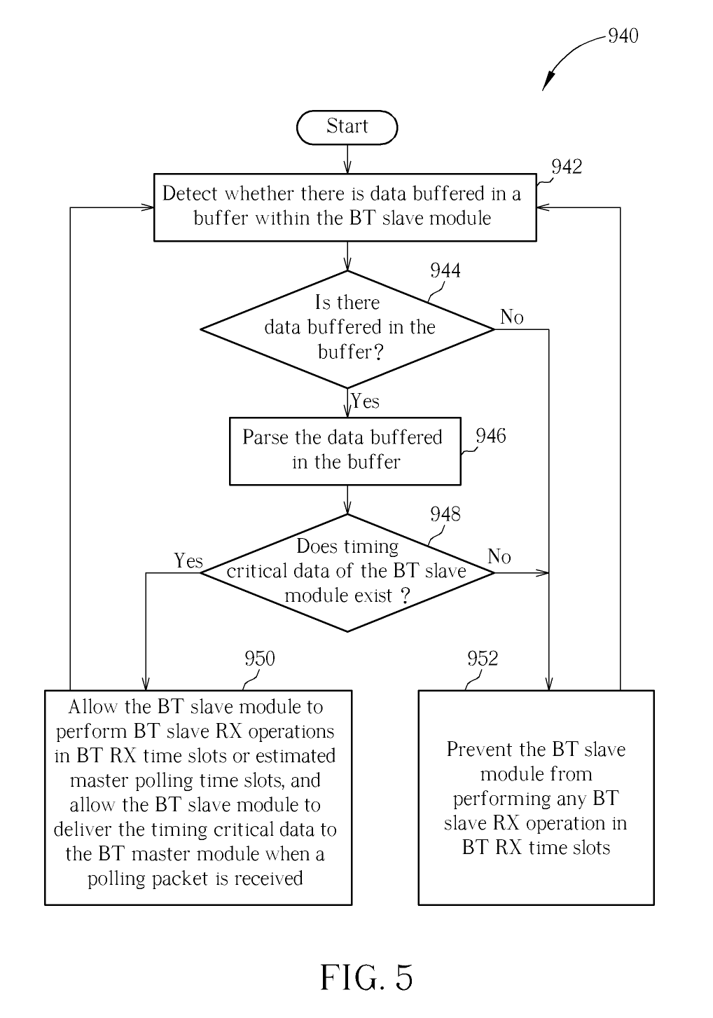

FIG. 5 illustrates a working flow 940 comprising implementation details of the method 910 shown in FIG. 2 according to another embodiment of the present invention. The controller 116 of this embodiment prevents the BT slave module 112 from performing wireless communication when it is detected that no timing critical data of the BT slave module 112 exists. More particularly, the controller 116 prevents the BT slave module 112 from performing any BT slave RX operation when it is detected that no timing critical data of the BT slave module 112 exists.

In Step 942, the controller 116 detects whether there is data buffered in the aforementioned buffer within the BT slave module 112.

In Step 944, the controller 116 determines whether there is data buffered in the aforementioned buffer within the BT slave module 112, based upon at least one detection result of the detection of Step 942. When it is detected that there is data buffered in the buffer, Step 946 is entered; otherwise, Step 952 is entered.

In Step 946, the controller 116 parses the data buffered in the buffer.

In Step 948, the controller 116 determines whether the timing critical data of the BT slave module 112 exists, based upon at least one parsing result of the parsing operation of Step 946. When it is detected that the timing critical data of the BT slave module 112 exists, Step 950 is entered; otherwise, Step 952 is entered.

In Step 950, the controller 116 allows the BT slave module 112 to perform BT slave RX operations in BT RX time slots or the estimated master polling time slots, and allows the BT slave module 112 to deliver the timing critical data to the BT master module when a polling packet is received. After Step 950 is executed, Step 942 is re-entered.

In Step 952, the controller 116 prevents the BT slave module 112 from performing any BT slave RX operation in BT RX time slots. After Step 952 is executed, Step 942 is re-entered.

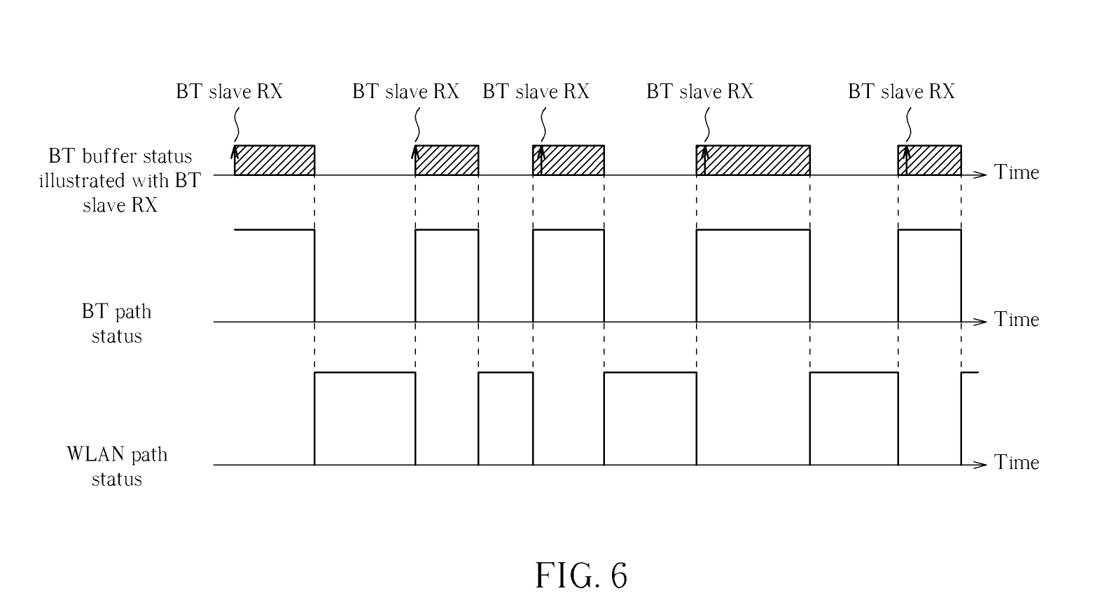

FIG. 6 illustrates the BT path status and the WLAN path status arranged based upon the BT buffer status according to the embodiment shown in FIG. 5. Similarly, the BT path status mentioned above represents the status of the aforementioned BT path, while the WLAN path status mentioned above represents the status of the aforementioned WLAN path. In addition, regarding the BT buffer status shown in FIG. 6, the shaded portions represent there is timing critical data buffered in the aforementioned buffer within the BT slave module 112, where the arrows labeled “BT slave RX” represent BT slave RX operations such as those mentioned above.

Please note that the controller 116 prevents the BT slave module 112 from performing any BT slave RX operation in BT RX time slots when it is detected that no timing critical data of the BT slave module 112 exists. Thus, when the WLAN path is in its active state, the controller 116 prevents the BT slave module 112 from performing any BT slave RX operation, and therefore, prevents the wireless communication of the WLAN module 114 from being hindered by any BT slave RX operation. As a result, the throughput of the WLAN module 114 can be greatly enhanced in contrast to the related art. Please be noted that the present invention is not limited to block every BT slave RX operation each time the BT buffer is detected to comprise no timing critical data. That is, the controller 116 may allow the BT slave module 112 to perform wireless communication under some specific circumstances, such as when BT's communication has been blocked for a predetermined time period.

According to an aspect of the present invention, the present invention provides a wireless communication module arranged to operate according to a first mechanism when timing critical data of the wireless communication module exists, and operate according to a second mechanism when no timing critical data of the wireless communication module exists. In particular, the wireless communication module represents the BT slave module 112 mentioned above. For example, the first mechanism represents the strategy of Step 930, and the second mechanism represents the strategy of Step 932. In another example, the first mechanism represents the strategy of Step 950, and the second mechanism represents the strategy of Step 952, where the BT slave module 112 suspends any BT slave receiving operation when no timing critical data of the BT slave module 112 exists, as disclosed in FIG. 5.

According to an aspect of the present invention, the present invention provides a wireless communication apparatus comprising a first wireless communication module and a second wireless communication module, wherein spectrums of signals respectively transceived by the first and the second wireless modules are overlapped. In particular, the wireless communication apparatus represents the wireless communication apparatus 100 mentioned above, where the first and the second wireless communication modules represent the BT slave module 112 and the WLAN module 114, respectively. For example, the wireless communication apparatus is arranged to parse data buffered in the first wireless communication module (e.g. the operations of Step 926 or Step 946), determine whether timing critical data of the first wireless communication module exists (e.g. the operations of Step 928 or Step 948), and control operation of the first wireless communication module or the second wireless communication module according to a determining result regarding the timing critical data (e.g. the operations of Step 930 or Step 932, or the operations of Step 950 or Step 952).

It is an advantage of the present invention that the present invention method and the associated wireless communication apparatus can properly maintain the timing critical data delivery of the BT slave module and minimize its impact on the throughput of the collocated WLAN module. In contrast to the related art, the present invention method and the associated wireless communication apparatus can greatly enhance the throughput of the WLAN module.

It is another advantage of the present invention that the present invention method and the associated wireless communication apparatus can save power by decreasing the number of BT slave RX operations.

Those skilled in the art will readily observe that numerous modifications and alterations of the device and method may be made while retaining the teachings of the invention.

What is claimed is:

1. A method for enhancing throughput of a Wireless Local Area Network (WLAN) module collocated with a Bluetooth (BT) slave module, the method comprising:
detecting whether timing critical data of the BT slave module exists; and
allowing the WLAN module to perform wireless communication when it is detected that no timing critical data of the BT slave module exists.

2. The method of claim 1, further comprising:
when it is detected that the timing critical data exists, allowing the BT slave module to deliver the timing critical data.

3. The method of claim 2, wherein the step of allowing the BT slave module to deliver the timing critical data further comprises:
when it is detected that the timing critical data exists, preventing the WLAN module from performing wireless communication.

4. The method of claim 1, wherein the step of detecting whether the timing critical data of the BT slave module exists further comprises:
detecting whether there is data buffered in a buffer within the BT slave module; and
determining that no timing critical data of the BT slave module exists when it is detected that there is no data buffered in the buffer.

5. The method of claim 1, wherein the step of detecting whether the timing critical data of the BT slave module exists further comprises:
detecting whether there is data buffered in a buffer within the BT slave module; and
when it is detected that there is data buffered in the buffer, parsing the data buffered in the buffer in order to detect whether the timing critical data of the BT slave module exists.

6. The method of claim 1, wherein the step of allowing the WLAN module to perform wireless communication when it is detected that no timing critical data of the BT slave module exists further comprises:
allowing the BT slave module to perform wireless communication except for when the WLAN module is performing wireless communication.

7. The method of claim 6, wherein the step of allowing the WLAN module to perform wireless communication when it is detected that no timing critical data of the BT slave module exists further comprises:
allowing the BT slave module to perform BT slave receiving operations except for when the WLAN module is performing wireless communication.

8. The method of claim 1, wherein the step of allowing the WLAN module to perform wireless communication when it is detected that no timing critical data of the BT slave module exists further comprises:
preventing the BT slave module from performing wireless communication when it is detected that no timing critical data of the BT slave module exists.

9. The method of claim 8, wherein the step of allowing the WLAN module to perform wireless communication when it is detected that no timing critical data of the BT slave module exists further comprises:
preventing the BT slave module from performing any BT slave receiving operation when it is detected that no timing critical data of the BT slave module exists.

10. The method of claim 1, wherein the BT slave module and the WLAN module are positioned within a wireless communication apparatus; and the wireless communication apparatus is a portable electronic device.

11. A wireless communication apparatus, comprising:
a Bluetooth (BT) slave module;
a Wireless Local Area Network (WLAN) module collocated with the BT slave module; and
a controller arranged to control operations of the BT slave module and the WLAN module, wherein the controller detects whether timing critical data of the BT slave module exists, and allows the WLAN module to perform wireless communication when it is detected that no timing critical data of the BT slave module exists.

12. The wireless communication apparatus of claim 11, wherein when it is detected that the timing critical data exists, the controller allows the BT slave module to deliver the timing critical data.

13. The wireless communication apparatus of claim 12, wherein when it is detected that the timing critical data exists, the controller prevents the WLAN module from performing wireless communication.

14. The wireless communication apparatus of claim 11, wherein the controller detects whether there is data buffered in a buffer within the BT slave module; and the controller determines that no timing critical data of the BT slave module exists when it is detected that there is no data buffered in the buffer.

15. The wireless communication apparatus of claim 11, wherein the controller detects whether there is data buffered in a buffer within the BT slave module; and when it is detected that there is data buffered in the buffer, the controller parses the data buffered in the buffer in order to detect whether the timing critical data of the BT slave module exists.

16. The wireless communication apparatus of claim 11, wherein the controller allows the BT slave module to perform wireless communication except for when the WLAN module is performing wireless communication.

17. The wireless communication apparatus of claim 16, wherein the controller allows the BT slave module to perform BT slave receiving operations except for when the WLAN module is performing wireless communication.

18. The wireless communication apparatus of claim 11, wherein the controller prevents the BT slave module from performing wireless communication when it is detected that no timing critical data of the BT slave module exists.

19. The wireless communication apparatus of claim 18, wherein the controller prevents the BT slave module from performing any BT slave receiving operation when it is detected that no timing critical data of the BT slave module exists.

20. The wireless communication apparatus of claim 11, wherein the wireless communication apparatus is a portable electronic device.

21. A wireless communication module, arranged to operate according to a first mechanism when timing critical data of the wireless communication module exists, and operate according to a second mechanism when no timing critical data of the wireless communication module exists.

22. The wireless communication module of claim 21, being a Bluetooth (BT) slave module.

23. The wireless communication module of claim 22, wherein the BT slave module suspends any BT slave receiving operation when no timing critical data of the BT slave module exists.

24. A wireless communication apparatus, comprising a first wireless communication module and a second wireless communication module, wherein spectrums of signals respectively transceived by the first and second wireless modules are overlapped, and the wireless communication apparatus is arranged to parse data buffered in the first wireless communication module, determine whether timing critical data of the first wireless communication module exists, and control operation of the first wireless communication module or the second wireless communication module according to a determining result regarding the timing critical data.
